(19) United States
(12) Patent Application Publication
(10) Pub. No.: US 2008/0241647 A1
(43) Pub. Date: Oct. 2, 2008

(54) CYLINDRICAL LITHIUM SECONDARY BATTERY

(75) Inventors: Atsushi FUKUI, Moriguchi-shi (JP); Hidekazu YAMAMOTO, Moriguchi-shi (JP); Yasuo TAKANO, Moriguchi-shi (JP); Shouichirou SAWA, Moriguchi-shi (JP); Taizou SUNANO, Moriguchi-shi (JP); Maruo KAMINO, Moriguchi-shi (JP)

Correspondence Address: WESTERMAN, HATTORI, DANIELS & ADRIAN, LLP, 1250 CONNECTICUT AVENUE, NW, SUITE 700, WASHINGTON, DC, 20036, US

(73) Assignee: SANYO ELECTRIC CO., LTD., Osaka (JP)

(21) Appl. No.: 12/056,661

(22) Filed: Mar. 27, 2008

(30) Foreign Application Priority Data
Mar. 28, 2007 (JP) 2007-083761

(51) Int. Cl. H01M 4/50; H01M 4/52; H01M 4/38; H01M 10/36; H01M 10/38

(52) U.S. Cl. 429/94; 29/623.5

(57) ABSTRACT

A cylindrical lithium secondary battery includes a positive electrode (1) having a positive electrode mixture layer disposed on a surface of a positive electrode current collector made of a conductive metal foil and containing a positive electrode active material, and a negative electrode (2) having a negative electrode mixture layer disposed on a surface of a negative electrode current collector made of a conductive metal foil and having a negative electrode active material containing silicon particles and/or silicon alloy particles. The amount of the positive electrode active material is 50 mg or less per 1 cm² of the positive electrode, the average particle size of the silicon particles and/or silicon alloy particles is from 5 μm to 15 μm, and the theoretical electrical capacity ratio of the negative electrode to the positive electrode is 1.2 or greater.

### BACKGROUND OF THE INVENTION

1. Field of the Invention

The present invention relates to a cylindrical lithium secondary battery having a positive electrode containing a lithium-transition metal composite oxide as a positive electrode active material, and a negative electrode containing silicon particles and/or silicon alloy particles as a negative electrode active material. The invention also relates to a manufacturing method of the battery.

2. Description of Related Art

In recent years, lithium secondary batteries have been used as new types of high power, high energy density secondary batteries. The lithium secondary battery uses a non-aqueous electrolyte and performs charge-discharge operations by transferring lithium ions between the positive and negative electrodes.

The lithium secondary batteries have been widely used as the power source for portable electronic devices related to information technology, such as mobile telephones and notebook computers, owing to their high energy density. It has been expected that, due to further size reduction and advanced functions of these portable devices, requirements for the lithium secondary batteries as the device power sources will continue to escalate in the future, and thus, demands for higher energy density in the lithium secondary batteries have been increasingly high.

An effective means for increasing the energy density of a battery is to use a material that has a large energy density as the active material. In view of this, various proposals and investigations have recently been made into the use of alloy materials of such elements as Al, Sn, and Si in lithium secondary batteries, as negative electrode active materials that can achieve a higher energy density. They are expected to be alternative negative electrode active materials to graphite, which has been in commercial use.

In the electrode that employs a material capable of alloying with lithium as the negative electrode active material, however, the negative electrode active material expands and shrinks in volume as it occludes and releases lithium, causing the negative electrode active material to pulverize or peel off from the negative electrode current collector. As a consequence, the current collection performance in the electrode deteriorates, and the charge-discharge cycle performance of the battery becomes poor.

In view of the problem, Japanese Published Unexamined Patent Application No. 2002-260637 discloses a negative electrode that exhibits good charge-discharge cycle performance. This negative electrode is formed by sintering a negative electrode mixture layer containing a negative electrode binder and a negative electrode active material composed of a material containing silicon under a non-oxidizing atmosphere.

However, even when the performance of the electrode itself improves, it is still difficult to fully exploit the advantageous effects of the electrode because there are many limitations in actual battery systems. Specifically, the details are as follows.

In actual batteries, in order to achieve high energy density, a spirally-wound electrode assembly, obtained by winding the positive electrode and the negative electrode so as to face each other together with a separator interposed therebetween, is accommodated in a cylindrical or prismatic container. In the battery with such a construction, the mechanical strengths of the positive and negative electrode current collectors and the separator are high (especially the one which uses a copper alloy as the negative electrode current collector to improve the negative electrode has a very high mechanical strength), so the spirally-wound electrode assembly itself does not easily deform. Therefore, when using the negative electrode active material that expands in volume due to occlusion of lithium as described above, the stress associated with the volumetric change of the negative electrode active material is applied entirely to the positive and negative electrodes and the separator, which are within the spirally-wound electrode assembly. This may result in breakage of the positive and negative electrodes resulting from the extension of the electrodes, squeeze-out of the electrolyte solution from the positive and negative electrode mixture layers because of the crushing of the mixture layers, and clogging of the separator because of the crushing of the separator. Consequently, the electron conductivity and the lithium ion conductivity in the battery deteriorate, causing various problems, such as deterioration of the charge-discharge performance.

In the cylindrical lithium secondary battery in particular, deformation of the spirally-wound electrode assembly is more difficult to occur than in the prismatic lithium secondary battery. In the prismatic lithium secondary battery, the horizontal cross-sectional shape of the spirally-wound electrode assembly comprises a linear portion and curved portions (semicircular portions). Therefore, when stress is applied thereto, the linear portion can bend easily although the curved portions do not easily deform, and a certain degree of deformation is possible. On the other hand, in the cylindrical lithium secondary battery, the horizontal cross-sectional shape of the spirally-wound electrode assembly is substantially circular, so there is no part in which deformation easily occurs. As a consequence, the adverse effects caused by the volumetric expansion of the negative electrode active material originating from the lithium occlusion arise more noticeably in the cylindrical lithium secondary battery. When the negative electrode active material deteriorates and the expansion develops as the charge-discharge cycles proceeds, the adverse effects become more serious, and further deterioration of the charge-discharge performance occurs.

Accordingly, it is a principal object of the present invention to provide a lithium secondary battery that achieves excellent charge-discharge cycle performance by improving the battery structure, the lithium secondary battery being a cylindrical lithium secondary battery employing as a negative electrode active material containing silicon and/or a silicon alloy, which causes volumetric expansion in occluding lithium. It is also an object of the invention to provide a method of manufacturing such a lithium secondary battery.

### BRIEF SUMMARY OF THE INVENTION

In order to accomplish the foregoing and other objects, the present invention provides a cylindrical lithium secondary battery comprising: a battery case; a non-aqueous electrolyte; and a spirally-wound electrode assembly accommodated in the battery case, the spirally-wound electrode assembly comprising a positive electrode, a negative electrode, and a separator interposed between the positive and negative electrodes, the positive electrode and the negative electrode being disposed facing each other across the separator, the positive electrode having a positive electrode current collector made of a conductive metal foil and a positive electrode mixture layer disposed on a surface of the positive electrode current collector, the positive electrode mixture layer comprising a positive electrode binder and a positive electrode active material containing a layered lithium-transition metal composite oxide represented by the chemical formula LiₐNi_{b}Co_{c}Mn_{d}AlₑO₂ where 0≦a≦1.1, b+c+d+e=1, 0≦b≦1, 0≦c≦1, 0≦d<1, and 0<e≦0.1, wherein the amount of the positive electrode active material is 50 mg or less per 1 cm² of the positive electrode, and the negative electrode having a negative electrode current collector made of a conductive metal foil and a negative electrode mixture layer disposed on a surface of the negative electrode current collector, the negative electrode mixture layer comprising a negative electrode binder and a negative electrode active material containing silicon particles and/or silicon alloy particles, wherein the average particle size of the silicon particles or the silicon alloy particles is from 5 μm to 15 μm, and wherein and the theoretical electrical capacity ratio of the negative electrode to the positive electrode is 1.2 or greater.

The present invention makes available a lithium secondary battery that achieves excellent charge-discharge cycle performance and a method of manufacturing the battery even when employing as a negative electrode active material containing silicon and/or a silicon alloy, which causes volumetric expansion when occluding lithium.

### BRIEF DESCRIPTION OF THE DRAWINGS

FIG. 1 is a cross-sectional view of the battery according to one embodiment of the present invention;

FIG. 2 is a front view illustrating a reference battery;

FIG. 3 is a cross-sectional view taken along line A-A in FIG. 2; and

FIG. 4 is a cross-sectional view illustrating the reference battery that has deformed.

### DETAILED DESCRIPTION OF THE INVENTION

A cylindrical lithium secondary battery according to the present invention comprises: a battery case; a non-aqueous electrolyte; and a spirally-wound electrode assembly accommodated in the battery case, the spirally-wound electrode assembly comprising a positive electrode, a negative electrode, and a separator interposed between the positive and negative electrodes, the positive electrode and the negative electrode being disposed facing each other across the separator, the positive electrode having a positive electrode current collector made of a conductive metal foil and a positive electrode mixture layer disposed on a surface of the positive electrode current collector, the positive electrode mixture layer comprising a positive electrode binder and a positive electrode active material containing a layered lithium-transition metal composite oxide represented by the chemical formula LiₐNi_{b}Co_{c}Mn_{d}AlₑO₂ where 0≦a≦1.1, b+c+d+e=1, 0≦b≦1, 0≦c≦1, 0≦d≦1, and 0≦e≦0.1, wherein the amount of the positive electrode active material is 50 mg or less per 1 cm² of the positive electrode, and the negative electrode having a negative electrode current collector made of a conductive metal foil and a negative electrode mixture layer disposed on a surface of the negative electrode current collector, the negative electrode mixture layer comprising a negative electrode binder and a negative electrode active material containing silicon particles and/or silicon alloy particles, wherein the average particle size of the silicon particles or the silicon alloy particles is from 5 μm to 15 μm, and wherein and the theoretical electrical capacity ratio of the negative electrode to the positive electrode is 1.2 or greater.

In the cylindrical battery employing a material containing silicon and/or a silicon alloy as a negative electrode active material, the lithium ion conductivity deteriorates as described previously. However, the present inventors have found that the degree of this adverse effect greatly varies depending on the specifications of the positive and negative electrodes. As a result, the present inventors have found that it becomes possible to minimize the deterioration of the lithium ion conductivity inherent to cylindrical lithium secondary battery and to obtain excellent charge-discharge performance by controlling the amount of the positive electrode active material to be 50 mg or less per 1 cm² of the positive electrode, the average particle size of the silicon particles or silicon alloy particles (hereafter also collectively referred to as “silicon/silicon alloy particles”) to be from 5 μm to 15 μm, and the theoretical electrical capacity ratio of the negative electrode to the positive electrode to be 1.2 or greater. The reasons arc as follows.

(1) Reasons for Restricting the Amount of the Positive Electrode Active Material to be 50 mg or Less Per 1 cm² of the Positive Electrode

When the amount of the positive electrode active material exceeds 50 mg per 1 cm² of the positive electrode, the thickness of the positive electrode mixture layer is too large for the electrolyte solution to infiltrate into the positive electrode mixture layer (into the region near the interface between the positive electrode current collector and the positive electrode mixture layer) easily, increasing the non-uniformity of the reactions and the electrochemical polarization in the battery. Therefore, the lithium ion conductivity reduces, and the charge-discharge performance deteriorates.

The worsening of the reaction uniformity and the increase of the electrochemical polarization in the battery can be promoting factors of the battery deterioration originating from the degradation and expansion of the silicon/silicon alloy particles in the battery employing a material containing silicon/silicon alloy particles as a negative electrode active material. Moreover, when the expansion of silicon/silicon alloy particles develops, the positive and negative electrodes and the separator are pressed and crushed further, and the lithium ion conductivity is deteriorated further. Consequently, the charge-discharge performance deteriorates further.

In view of this problem, when the amount of the positive electrode active material is controlled to be 50 mg or less per 1 cm² of the positive electrode, the electrolyte solution are allowed to infiltrate into the positive electrode mixture layer easily since the thickness of the positive electrode mixture layer is not too large. As a result, the non-uniformity of the reactions and the electrochemical polarization are minimized in the battery. Moreover, this suppresses the battery deterioration due to the degradation and expansion of the silicon/silicon alloy particles. Furthermore, since the expansion of the silicon/silicon alloy particles is suppressed, the compression and squashing of the positive and negative electrodes and the separator are minimized. For these reasons, the deterioration of the lithium ion conductivity can be prevented, and the deterioration of the charge-discharge performance, which is associated with the progress of charge-discharge cycle, can be minimized.

### (2) The Reason Why the Average Particle Size of the Negative Electrode Active Material, Silicon/Silicon Alloy Particles, Should be Controlled to be From 5 μm to 15 μm

When the silicon/silicon alloy particles have an average particle size of less than 5 μm, the total surface area of the silicon/silicon alloy particles in the negative electrode active material is accordingly large, and the contact area between the silicon/silicon alloy particles and the electrolyte solution is also large. As a consequence, the deterioration of the silicon/silicon alloy particles (degradation or expansion) because of the side reaction with the electrolyte solution tends to proceed easily. In addition, when the surface area of the negative electrode active material is large, the amount of the electrolyte solution retained in the negative electrode mixture layer is accordingly large. This leads to an imbalance in the amounts of the electrolyte solution between the positive and negative electrodes, and the non-uniformity of the reactions in the battery exacerbates. On the other hand, when the silicon/silicon alloy particles have an average particle size of greater than 15 μm, the absolute amount of the volumetric expansion of each one of the silicon/silicon alloy particles is large when occluding lithium. Therefore, the degree of crushing of the positive and negative electrodes and the separator increases, resulting in significant deterioration of the lithium ion conductivity. For these reasons, the charge-discharge performance deteriorates.

In contrast, when the average particle size of the negative electrode active material, the silicon/silicon alloy particles, is controlled to be from 5 μm to 15 μm, the contact area of the silicon/silicon alloy particles with the electrolyte solution can be kept small, and accordingly it is possible to prevent the deterioration of the silicon/silicon alloy particles (degradation and expansion) resulting from the side reaction with the electrolyte solution. Moreover, since the surface area of the negative electrode active material is kept from becoming excessively large, the amount of the electrolyte solution retained in the negative electrode mixture layer is not too large and the amounts of the electrolyte solution are well-balanced between the positive and negative electrodes, making it possible to ensure the uniformity in the reactions. Furthermore, since the average particle size of the silicon/silicon alloy particles is appropriate, the absolute amount of the volumetric expansion of each one of the silicon/silicon alloy particles does not become excessively large. Accordingly, the crushing of the positive and negative electrodes and the separator is prevented, and good lithium ion conductivity can be maintained. As a result, the charge-discharge performance deterioration originating from repeated charge-discharge operations can be minimized.

### (3) The Reason Why the Theoretical Electrical Capacity Ratio of the Negative Electrode to the Positive Electrode Should be Controlled to be 1.2 or Greater

When the theoretical electrical capacity ratio of the negative electrode to the positive electrode is less than 1.2, the amount of lithium occluded per one atom of silicon etc. is large, and accordingly the volumetric expansion ratio of the silicon/silicon alloy particles during charge is large, accelerating the occurrence of the fractures in the silicon/silicon alloy particles. When fractures occur in the silicon/silicon alloy particles, newly exposed surfaces are produced thereon, and the active area that comes in contact with the electrolyte solution increases, and consequently, degradation and expansion of the silicon/silicon alloy particles develop. As a consequence, the expansion of the negative electrode active material, which is associated with the progress of charge-discharge cycle, is promoted, and the charge-discharge performance is deteriorated.

In contrast, when the theoretical electrical capacity ratio of the negative electrode to the positive electrode is controlled to be 1.2 or greater, the amount of lithium occluded per one atom of silicon etc. is small, and accordingly the volumetric expansion ratio of the silicon/silicon alloy particles during charge is small, lessening the occurrence of the fractures in the silicon/silicon alloy particles. Accordingly, the production of the newly exposed surfaces is lessened, so the active area that comes in contact with the electrolyte solution is reduced. The degradation and expansion of the silicon/silicon alloy particles are therefore minimized. As a result, the development of the expansion of the negative electrode active material, which is associated with the process of charge-discharge cycle, is suppressed, and the consequent deterioration of the charge-discharge performance is prevented.

It is desirable that the amount of the positive electrode active material be 10 mg or greater per 1 cm² of the positive electrode. If the amount of the positive electrode active material is less than 10 mg per 1 cm² of the positive electrode, the battery cannot achieve high energy density because the proportion of the positive electrode active material relative to the positive electrode current collector is too small (i.e., the proportion of the positive electrode active material is too small within the electrode assembly).

It is desirable that the theoretical electrical capacity ratio of the negative electrode to the positive electrode be 4.0 or less. If the theoretical electrical capacity ratio exceeds 4.0, the battery cannot achieve high energy density because the amount of the positive electrode active material relative to the amount of the negative electrode active material is too small within the electrode assembly (i.e., the proportion of the positive electrode active material in the electrode assembly is too small).

Examples of the layered lithium-transition metal composite oxide represented by the foregoing chemical formula include LiCoO₂, LiCo_{0.99}Al_{0.01}O₂, LiNiO₂, LiMnO₂, LiCo_{0.5}Ni_{0.5}O₂, LiCo_{0.7}Ni_{0.3}O₂, LiCo_{0.8}Ni_{0.2}O₂, LiCo_{0.82}Ni_{0.18}O₂, LiCo_{0.8}Ni_{0.15}Al_{0.05}O₂, LiNi_{0.4}Co_{0.3}Mn_{0.3}O₂, and LiNi_{0.33}Co_{0.33}Mn_{0.34}O₂.

Herein, it is preferable that the positive electrode contain Li₂CO₃, and the amount of the Li₂CO₃ with respect to the total amount of the positive electrode active material be 0.2 mass % or greater.

During charge, in other words, when lithium is deintercalated from the positive electrode active material and the potential of the positive electrode is elevated, Li₂CO₃ in the positive electrode is decomposed by the elevated potential, and CO₂ is generated. The CO₂ serves to smoothly cause the lithium occlusion/release reactions at the negative electrode active material surface and additionally to lessen the side reactions. Therefore, the deterioration (expansion) of the silicon/silicon alloy particles is lessened. The amount of the Li₂CO₃ with respect to the total amount of the positive electrode active material is restricted to 2 mass % or greater because the advantageous effect obtained by adding Li₂CO₃ may not be sufficient when the amount is less than 0.2 mass %.

It is desirable that the amount of the Li₂CO₃ with respect to the total amount of the positive electrode active material be 5 mass % or less. If the amount exceeds 5 mass %, the amount of CO₂ produced by the decomposition of Li₂CO₃, which results from the elevation of the positive electrode potential, will be too large, which means that a large amount of CO₂ gas exists in the battery. This raises the battery internal pressure, which can be a cause of deformation of the battery case.

It should be noted that the effect of improving the charge-discharge cycle performance resulting from the Li₂CO₃ can be made more effective by dissolving CO₂ in the non-aqueous electrolyte in advance, when fabricating the battery.

It is more preferable that the Li₂CO₃ exist on a surface of the positive electrode active material.

When the Li₂CO₃ exists on the surface of the positive electrode active material, the generation of CO₂ originating from the decomposition of the Li₂CO₃ occurs more easily when the positive electrode potential is elevated. As a result, the effect of minimizing the expansion of the silicon/silicon alloy particles, which is obtained by CO₂, becomes more significant.

The methods of causing Li₂CO₃ to exist on the surface of positive electrode active material (i.e., the lithium-transition metal composite oxide) include a method of allowing Li₂CO₃ used as a source material during the preparation of the lithium-transition metal composite oxide to remain thereon even after the preparation, and a method of producing Li₂CO₃ by causing a lithium component in the lithium-transition metal composite oxide with CO₂ in the ambient gas during the preparation or with CO₂ in the atmosphere. In the latter case, especially, if Ni exists in a large amount in the lithium-transition metal composite oxide, Li₂CO₃ tends to be generated easily by the reaction between CO₂ and the lithium component in the oxide. Accordingly, in the present invention, it is preferable that the lithium-transition metal composite oxide used as the positive electrode active material contain a greater amount of Ni component, because the effect of improving the charge-discharge cycle performance resulting from Li₂CO₃ is more significant when the amount of the Ni component is greater.

It is preferable that the positive electrode active material contain a layered lithium-transition metal composite oxide represented by the chemical formula LiₐNi_{b}Co_{c}AlₑO₂, where 0≦a≦1.1, b+c+e=1, 0≦b<0.85, 0<c≦0.2, and 0≦e≦0.1.

The lithium-transition metal composite oxides commonly used as positive electrode active materials such as LiCoO₂ and LiNi_{0.34}Co_{0.33}Mn_{0.33}O₂ do not have a highly stable crystal structure, so when the potential is high during charge (when a large amount of lithium is deintercalated), transition metal ions dissolve away from the oxide and migrate to the negative electrode surface, forming a metal deposit on the negative electrode surface. At this time, a side reaction with the electrolyte solution takes place simultaneously, the reaction product also deposits on the negative electrode surface. Since this deposit inhibits the lithium ion conduction to the negative electrode, non-uniformity of the reactions in the battery increases. As a consequence, the deterioration of the silicon/silicon alloy particles is promoted as the charge-discharge cycles are repeated, and the charge-discharge performance is deteriorated.

In contrast, the lithium-transition metal composite oxide represented by the foregoing chemical formula has a highly stable crystal structure, so even when the potential is high during charge (when a large amount of lithium is deintercalated), it is possible to hinder the transition metal ions from dissolving away from the oxide and migrating to the negative electrode surface and to hinder the metal deposit from forming on the negative electrode surface. Accordingly, the deposition of the reaction product on the negative electrode surface is lessened, and the lithium ion conduction to the negative electrode is not hampered. Thus, uniformity of the reactions in the battery can be ensured. As a result, the deterioration of the silicon/silicon alloy particles is prevented, and therefore the charge-discharge performance deterioration is minimized.

In addition, since the lithium-transition metal composite oxide represented by the foregoing chemical formula inevitably contains a Ni component, it tends to easily generate Li₂CO₃ through the reaction between the lithium component in the oxide and CO₂. As a result, the effect of hindering the expansion of the silicon/silicon alloy particles, which results from the Li₂CO₃, is exhibited more effectively.

Examples of the compositions of the lithium-transition metal composite oxide that can more effectively obtain the effect of preventing the transition metal ions from dissolving away and the effect of hindering the expansion of the silicon/silicon alloy particles by Li₂CO₃ include substances containing a large amount of Ni, such as LiNi_{0.8}Co_{0.2}O₂ and LiₐNi_{0.8}Co_{0.15}Al_{0.05}O₂, which are particularly preferable.

It is preferable that the separator be made of a microporous polyethylene film, and the microporous film have a penetration resistance of 350 g or greater and a porosity of 40% or greater.

The separator having a penetration resistance of 350 g or greater and a porosity of 40% or greater has a large separator strength and moreover ensures a sufficient pore volume within the separator, and is therefore less likely to cause the clogging due to the crushing of the separator even when the expansion of the silicon/silicon alloy particles develops. As a result, good cycle performance is maintained.

It is desirable that the silicon/silicon alloy particles have a crystallite size of 100 nm or less.

When the silicon/silicon alloy particles have a crystallite size of 100 nm or less, a large number of crystallites can exist in a particle since the crystallite size is small relative to the particle size. In this case, since the orientations of the crystallites are disordered, polycrystalline silicon particles or the like, which have a small crystallite size, have a structure that is less susceptible to fractures than monocrystalline silicon particles or the like.

In addition, a small crystallite size of 100 nm or less means that a large number of grain boundaries, which serve as the paths for passing lithium, can exist in the silicon/silicon alloy particles since the crystallite size is small relative to the size of the silicon/silicon alloy particles. Therefore, grain boundary diffusion of lithium facilitates the migration of lithium into the silicon/silicon alloy particles during charge and discharge, uniformity of the reactions in the silicon/silicon alloy particles becomes very high. As a result, the amounts of volumetric change in the silicon/silicon alloy particles are made uniform, and the fractures of the silicon/silicon alloy particles, which result from the large strain within the silicon/silicon alloy particles, are minimized.

When the fractures of the silicon/silicon alloy particles are minimized in this way, the newly exposed surfaces, which are highly reactive with the non-aqueous electrolyte solution, do not increase during the charge-discharge reactions, and accordingly it is also possible to minimize the expansion of the silicon/silicon alloy particles associated with the degradation from the newly exposed surfaces, which results from the side reaction with the non-aqueous electrolyte solution. Thus, it becomes possible to suppress the squeeze-out of the electrolyte solution from the positive and negative electrode active material layers resulting from the crushing of the active material layers, and the clogging of the separator resulting from the separator crushing, which are due to the expansion of the silicon/silicon alloy particles. Therefore, excellent cycle performance can be obtained.

It is desirable that the silicon/silicon alloy particles have a crystallite size of 1 nm or greater. The reason is that the silicon/silicon alloy particles having a crystallite size of less than 1 nm are difficult to prepare even with, for example, the later-described thermal decomposition of a silane compound.

It is desirable that the silicon/silicon alloy particles be prepared by thermal decomposition or thermal reduction of a material containing a silane compound.

The reason why it is preferable to use the silicon/silicon alloy particles prepared by thermal decomposition or thermal reduction is that the use of such methods makes it easy to obtain silicon/silicon alloy particles having a crystallite size of 100 nm or less.

It is desirable that the silicon/silicon particles contain, as impurities, oxygen and at least one element selected from the group consisting of phosphorus, boron, aluminum, iron, calcium, sodium, gallium, lithium, and indium.

When at least one of the just-mentioned impurities is contained in the silicon/silicon particles, the electron conductivity of the silicon particles is improved. Therefore, the current collection performance within the negative electrode active material layer improves, and uniformity of the electrode reaction also improves. It should be noted that oxygen is included in addition to the impurities such as phosphorus because oxygen is unavoidably present because of the surface oxidation of silicon.

Among the above-listed impurities, phosphorus and boron are particularly preferable. Phosphorus and boron can form a solid solution with silicon if they are present in an amount of several hundred ppm. When a solid solution forms in this way, the electron conductivity in the negative electrode active material particles further improves. Such silicon in which phosphorus or boron is contained in the form of solid solution may be formed preferably by adding a phosphorus source or a boron source, such as phosphine (PH₃) or diborane (B₂H₆), in an appropriate amount, to a silane compound that is a source material in the thermal decomposition or the thermal reduction.

It is desirable that the negative electrode binder be a thermoplastic resin.

When the negative electrode binder is thermoplastic, the thermal bonding effect of the negative electrode binder is obtained by carrying out the heat treatment in preparing the electrode within the temperature range in which the negative electrode binder exhibits plastic properties, in other words, at a temperature higher than the glass transition temperature or the melting point of the negative electrode binder. Thus, adhesion of the negative electrode active material particles with one another and adhesion of the negative electrode active material with the negative electrode current collector improve significantly, resulting in excellent charge-discharge performance.

It is desirable that the thermoplastic resin be a polyimide resin.

Among various polymer materials, the polyimide resin has a very high mechanical strength. Owing to the high mechanical strength, the stress that presses the silicon/silicon alloy particles toward the negative electrode current collector side works strongly when the silicon/silicon alloy particles expand in volume during charge. This stress serves to suppress the development of the expansion of the silicon/silicon alloy particles due to their degradation even when the charge-discharge cycle progresses. This is due to the nature of the silicon/silicon alloy particles that the development of the expansion tends to be hindered by applying an external force thereto during charge/discharge.

It is desirable that the negative electrode mixture layer contain graphite powder.

The addition of graphite powder to the negative electrode mixture layer allows conductive network to form in the negative electrode mixture layer, improving the electron conductivity in the negative electrode mixture layer. Thus, uniformity in the reactions improves. As a result, the development of the expansion of the silicon/silicon alloy particles, which is associated with the process of charge-discharge cycle, is suppressed, and the charge-discharge performance is therefore improved.

It is preferable that the graphite powder have an average particle size of from 3 μm to 15 μm, and the amount of the graphite powder with respect to the total amount of the negative electrode active material is from 3 mass % to 20 mass %.

The average particle size of the graphite powder is restricted to be from 3 μm to 15 μm for the following reason.

If the average particle size of graphite powder is less than 3 μm, the total surface area of the graphite powder contained in the negative electrode mixture layer is large. Accordingly, the amount of the negative electrode binder that exists on the graphite powder surface is large, and the amount of the negative electrode binder that exists on the negative electrode active material surface is correspondingly small. As a consequence, the binding effect of the negative electrode binder becomes poor, resulting in poor charge-discharge cycle performance. On the other hand, if the average particle size of the graphite powder exceeds 15 μm, the number of the graphite powder particles per mass is so small that a sufficient conductive network cannot be formed in the negative electrode mixture layer, and the effect of increasing reaction uniformity cannot be fully obtained.

The amount of graphite powder with respect to the total amount of the negative electrode active material is restricted to be from 3 mass % to 20 mass % for the following reason.

If the amount of the graphite powder added is less than 3 mass %, the amount of the graphite powder is so small that the conductive network cannot be formed sufficiently in the negative electrode mixture layer and the effect of increasing reaction uniformity cannot be fully obtained. On the other hand, if the amount of the graphite powder added exceeds 20 mass %, the amount of the negative electrode binder that exists on the graphite powder surface is large while the amount of the negative electrode binder that exists on the negative electrode active material surface becomes correspondingly small. Consequently, the binding effect on the negative electrode active material originating from the negative electrode binder becomes poor, resulting in poor charge-discharge cycle performance.

It is desirable that the non-aqueous electrolyte contain CO₂ and/or fluoroethylene carbonate.

CO₂ and carbonates containing fluorine (such as fluoroethylene carbonate) have the effect of allowing the reactions on the surface of the silicon/silicon alloy particles with lithium to take place smoothly and therefore serve to improve the uniformity of the reactions in the negative electrode. Thus, the expansion of the silicon/silicon alloy particles is suppressed, and as a result, the cycle performance is improved.

In order to accomplish the foregoing object, the present invention also provides a method of manufacturing a cylindrical lithium secondary battery, comprising: applying a positive electrode mixture slurry containing a positive electrode binder and a positive electrode active material onto a surface of a positive electrode current collector made of a conductive metal foil so that the amount of the positive electrode active material is 50 mg or less per 1 cm² of the positive electrode, the positive electrode active material containing a layered lithium-transition metal composite oxide represented by the chemical formula LiₐNi_{b}Co_{c}Mn_{d}Al_{c}O₂ where 0≦a≦1.1, b+c+d+e=1, 0≦b≦1, 0≦c≦1, 0≦d≦1, and 0≦e≦0.1, to thereby prepare a positive electrode in which a positive electrode mixture layer is formed on the surface of the positive electrode current collector; applying a negative electrode mixture slurry containing a negative electrode binder and a negative electrode active material containing silicon particles and/or silicon alloy particles having an average particle size of from 5 μm to 15 μm, onto a surface of a negative electrode current collector made of a conductive metal foil so that the theoretical electrical capacity ratio of the negative electrode to the positive electrode is 1.2 or greater, to thereby prepare a negative electrode in which a negative electrode mixture layer is formed on the surface of the negative electrode current collector; and spirally winding the positive and negative electrodes with a separator interposed therebetween to prepare a spirally-wound electrode assembly, thereafter putting the spirally-wound electrode assembly into a battery case, and filling a non-aqueous electrolyte into the battery case.

With this method, it is possible to fabricate the above-described cylindrical lithium secondary battery smoothly.

It is desirable that the silicon/silicon alloy particles used should be prepared by thermal decomposition or thermal reduction of a material containing a silane compound.

This method makes it possible to prepare silicon/silicon alloy particles having a crystallite size of 100 nm or less, so it becomes possible to minimize the fractures of the silicon/silicon alloy particles that originate from, for example, a large strain in the negative electrode active material particles. This suppresses the squeeze-out of the electrolyte solution from the positive and negative electrode active material layers resulting from the crushing of the active material layers, and the clogging of the separator resulting from the separator crushing, which are due to the expansion of the silicon/silicon alloy particles associated with the progress of charge-discharge cycle. Therefore, the cycle performance can be improved.

Examples of the silane compound include trichlorosilane (SiHCl₃), monosilane (SiH₄), and disilane (Si₂H₆).

In order to produce silicon/silicon alloy particles with a smaller crystallite size, it is preferable that the temperature at which the silane compound is thermally decomposed be as low as possible. The reason is that the lower the temperature of the thermal decomposition is, the more likely the particles with a smaller crystallite size can be produced.

Here, when trichlorosilane (SiHCl₃) is used as the source material in the thermal decomposition or the thermal reduction, the minimum temperature necessary for the thermal decomposition at which the silicon/silicon alloy particles can be deposited appropriately is about 900° C. to 1000° C. When monosilane (SiH₄) is used, the minimum temperature is about 600° C. to 800° C., so the deposition of the silicon/silicon alloy particles is possible at a lower temperature. Therefore, it is preferable that in preparing silicon/silicon alloy particles having a small crystallite size suitable for the present invention, monosilane (SiH₄) be used as the source material.

It is more preferable that the silicon/silicon alloy particles be prepared by pulverizing and classifying a silicon ingot prepared by thermal decomposition or thermal reduction.

In the case that grain boundaries exist in a silicon ingot, mechanical pulverization of the ingot causes fractures along the grain boundaries. The silicon ingot having a small crystallite size that is prepared by thermal decomposition or thermal reduction has a large number of grain boundaries. Therefore, if the ingot is pulverized until the particles have an average particle size of 5 μm to 15 μm, which is considered suitable for the present invention, a large number of grain boundary surfaces will appear at the particle surface, and the particles will have extremely irregular surfaces. When the surfaces of the silicon/silicon alloy particles have such irregularities, the negative electrode binder goes into such irregular portions, exerting an anchoring effect. Therefore, adhesion of the silicon/silicon alloy particles with one another improves further.

In the case that the negative electrode binder is thermoplastic, the negative electrode binder can go into the irregularities in the surfaces of the silicon/silicon alloy particles more (i.e., the heat bonding effect of the negative electrode binder can become more significant) by carrying out the heat treatment in preparing the electrode at a temperature above the thermoplastic region of the negative electrode binder, and therefore, the adhesion improves still further. When the degree of adhesion in the negative electrode is higher, the current collection performance can be kept higher even if the silicon/silicon alloy particles undergo volumetric changes by charge and discharge. Accordingly, the uniformity of the reactions in the negative electrode improves, and the development of the expansion of the silicon/silicon alloy particles due to their deterioration is suppressed. Accordingly, it becomes possible to suppress the squeeze-out of the electrolyte solution from the positive and negative electrode active material layers resulting from the crushing of the active material layers, and the clogging of the separator resulting from the separator crushing. Therefore, the cycle performance improves.

### DESCRIPTION OF PREFERRED EMBODIMENTS

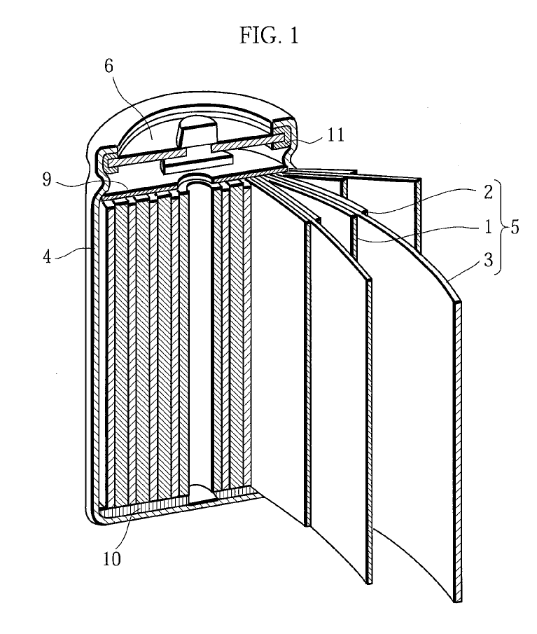

Hereinbelow, preferred embodiments of the cylindrical lithium secondary battery according to the invention will be described with reference to FIG. 1. It should be construed, however, that the embodiments of the cylindrical lithium secondary battery according to the invention are not limited to those described hereinbelow, but various changes and modifications are possible without departing from the scope of the invention.

### Fabrication of Cylindrical Lithium Secondary Battery

### Preparation of Positive Electrode

Li₂CO₃ and CoCO₃ were mixed in a mortar so that the mole ratio of Li and Co became 1:1. Thereafter, the mixture was sintered in an air atmosphere at 800° C. for 24 hours and then pulverized to obtain a lithium-cobalt composite oxide represented as LiCoO₂ (positive electrode active material particles having an average particle size of 11 μm). The resultant positive electrode active material particles had a BET specific surface area of 0.37 m²/g. The amount of the Li₂CO₃ contained in the positive electrode active material was determined, and it was found to be 0.05 mass % with respect to the net LiCoO₂ (not containing Li₂CO₃). The amount of Li₂CO₃ was determined as follows. The positive electrode active material particles were dispersed in pure water and subjected to ultrasonication for 10 minutes. Then, the resultant solution was filtered to remove the net Li₂CO₃ and filtrate was obtained. The resultant filtrate was titrated with 0.1N HCl aqueous solution, to obtain the amount of Li₂CO₃.

Next, the LiCoO₂ powder, carbon material powder as a positive electrode conductive agent, and polyvinylidene fluoride as a positive electrode binder were added to N-methyl-2-pyrrolidone) as a dispersion medium so that the weight ratio of the positive electrode active material, the positive electrode conductive agent, and the positive electrode binder became 95:2.5:2.5. Thereafter, the mixture was kneaded to prepare a positive electrode mixture slurry.

Next, the resultant positive electrode active material slurry was applied onto both sides of an aluminum foil serving as the positive electrode current collector (thickness: 15 μm, length: 530 mm, width: 33.7 mm) so that the applied area has a length of 500 mm and a width of 33.7 mm on both sides. Thereafter, the resultant material was dried and pressure-rolled. The amount of the positive electrode mixture layer on the positive electrode current collector was 38 mg/cm². Then, an aluminum plate serving as a positive electrode current collector tab was connected to an end portion of the positive electrode on which the positive electrode mixture layer was not formed.

### Preparation of Negative Electrode

First, a polycrystalline silicon ingot was prepared by thermal reduction. Specifically, silicon seeds placed in a metal reactor (reducing furnace) were heated to 800° C. by passing electric current therethrough, and a mixed gas of hydrogen gas and a gas vapor of high-purity monosilane (SiH₄) was flowed therethrough, so that polycrystalline silicon was deposited on the surfaces of the silicon seeds. Thereby, a polycrystalline silicon ingot was formed into a thick rod shape.

Next, the polycrystalline silicon ingot was pulverized and classified to prepare polycrystalline silicon particles (i.e., negative electrode active material particles) having a purity of 99%. The polycrystalline silicon particles had a crystallite size of 32 nm and an average particle size of 10 μm. The crystallite size was calculated from the half-width of silicon (111) peak measured by a powder X-ray diffraction analysis, using Scherrer's formula. The average particle size was determined by laser diffraction analysis.

Next, the above-described negative electrode active material particles, graphite powder (average particle size: 3.5 μm) as a negative electrode conductive agent, and a polyamic acid varnish (solvent: NMP, concentration: 47 mass %, determined as the amount of the polyimide resin after imidization by a heat treatment) were mixed together with N-methyl-2-pyrrolidone (NMP) as a dispersion medium so that the weight ratio of the negative electrode active material particles, the negative electrode conductive agent powder, and the polyimide resin after imidization became 100:3:8.6. The polyamic acid varnish is a precursor of a thermoplastic polyimide resin having a glass transition temperature 300° C. and serving as negative electrode binder. Thus, a negative electrode mixture slurry was obtained.

Thereafter, in an air atmosphere at 25° C., the just-described negative electrode mixture slurry was applied onto both sides of a negative electrode current collector made of a 18 μm-thick copper alloy foil (C7025 alloy foil, containing 96.2 mass % of Cu, 3.0 mass % of Ni, 0.65 mass % of Si, and 0.15 mass % of Mg) that had been roughed so as to have a surface roughness Ra (defined by Japanese Industrial Standard (JIS) B 0601-1994) of 0.25 μm and a mean spacing of local peaks S (also defined by JIS B 0601-1994) of 0.85 μm. Thereafter, the resultant material was dried in the air at 120° C. and pressure-rolled in the air at 25° C. Finally, the resultant article was cut out into a rectangle shape with a length of 540 mm×a width of 35.7 mm, and thereafter subjected to a heat treatment at 400° C. for 10 hours under an argon atmosphere, to thus prepare a negative electrode in which a negative electrode active material was formed on the surfaces of the negative electrode current collector. The amount of the negative electrode mixture layer on the negative electrode current collector was 5.6 mg/cm², and the thickness of the negative electrode mixture layer was 56 μm. Then, a nickel plate serving as a negative electrode current collector tab was connected to an end portion of the negative electrode.

### Preparation of Non-Aqueous Electrolyte Solution

Lithium hexafluorophosphate (LiPF₆) was dissolved at a concentration of 1.0 mole/L in a mixed solvent of 3:7 volume ratio of ethylene carbonate (EC) and diethyl carbonate (DEC), and thereafter, 0.4 mass % of carbon dioxide and 10 mass % of fluoroethylene carbonate were added thereto, to thus prepare a non-aqueous electrolyte solution.

### Preparation of Electrode Assembly and Battery

Using a sheet of the positive electrode, a sheet of the negative electrode, and two sheets of separators made of a microporous polyethylene film with a thickness of 20 μm, a length of 600 mm, and a width of 37.7 mm (penetration resistance: 340 g, porosity: 39%), the positive electrode and the negative electrode were disposed facing each other with a separator interposed between them, and the positive and negative electrodes with the separators were spirally wound using a winding core having a diameter of 4 mm so that the positive electrode tab is located at the innermost roll while the negative electrode tab is at the outermost roll. Subsequently, the winding core was drawn out, and thus, a spirally-wound electrode assembly with a diameter of 12.8 mm and a height of 37.7 mm was prepared. Lastly, the spirally-wound electrode assembly and the electrolyte solution were inserted into a closed-bottom cylindrical battery case made of SUS in a CO₂ atmosphere at 25° C. and 1 atm. The battery case was then sealed to complete a battery.

The specific construction of the cylindrical lithium secondary battery is as follows. As illustrated in FIG. 1, the battery has a closed-bottom cylindrical metal battery can 4 having an opening at its top end, an electrode assembly 5 in which a positive electrode 1 and a negative electrode 2 are spirally wound so as to face each other with a separator 3 interposed therebetween, a non-aqueous electrolyte solution impregnated in the electrode assembly 5, and a sealing lid 6 for sealing the opening of the metal battery can 4. The sealing lid 6 serves as a positive electrode terminal, while the metal battery can 4 serves as a negative electrode terminal. The positive electrode current collector tab (not shown), which is attached to the upper side of the electrode assembly 5, is connected to the sealing lid 6, and the negative electrode current collector tab (not shown), which is attached to the lower side of the electrode assembly 5, is connected to the metal battery can 4, whereby a structure that enables charging and discharging as a secondary battery is formed. The upper and lower faces of the electrode assembly 5 is covered with an upper insulating plate 9 and a lower insulating plate 10, respectively, for insulating the electrode assembly 5 from the metal battery can 4 and so forth. The sealing lid 6 is fixed to the opening of the metal battery can 4 by crimping it with an insulative packing 11 interposed therebetween. It should be noted that the battery fabricated in this manner had a diameter of 14 nm and a height of 43 mm.

### EXAMPLES

### First Group of Examples

### Example A1

A battery fabricated in the same manner as described in the foregoing embodiment was used as a battery of Example A1.

The battery fabricated in this manner is hereinafter referred to as Battery A1 of the invention.

### Examples A2 and A3

Batteries were fabricated in the same manner as described in Example A1 above, except that the amounts of the negative electrode mixture layer on the negative electrode current collector were set at 4.3 mg/cm² and 3.6 mg/cm².

The batteries fabricated in this manner are hereinafter referred to as Batteries A2 and A3 of the invention, respectively.

### Example A4

A battery was fabricated in the same manner as described in Example A1 above, except that the amount of the positive electrode mixture layer on the positive electrode current collector was set at 43 mg/cm².

The battery fabricated in this manner is hereinafter referred to as Battery A4 of the invention.

### Example A5

A battery was fabricated in the same manner as described in Example A4 above, except that the amount of the negative electrode mixture layer on the negative electrode current collector was set at 3.6 mg/cm.

The battery fabricated in this manner is hereinafter referred to as Battery A5 of the invention.

### Example A6

A battery was fabricated in the same manner as described in Example A1 above, except that the amount of the positive electrode mixture layer on the positive electrode current collector was set at 50 mg/cm².

The battery fabricated in this manner is hereinafter referred to as Battery A6 of the invention.

### Example A7

A battery was fabricated in the same manner as described in Example A6 above, except that the amount of the negative electrode mixture layer on the negative electrode current collector was set at 4.3 mg/cm².

The battery fabricated in this manner is hereinafter referred to as Battery A7 of the invention.

### Examples A8 and A9

Batteries were fabricated in the same manner as described in Example A1 above, except that the average particle sizes of the negative electrode active material were set at 5.5 μm and 14.5 μm, respectively.

The batteries fabricated in this manner are hereinafter referred to as Batteries A8 and A9 of the invention, respectively.

### Comparative Example Z1

A battery was fabricated in the same manner as described in Example A1 above, except that the amount of the negative electrode mixture layer on the negative electrode current collector was set at 3.0 mg/cm².

The battery fabricated in this manner is hereinafter referred to as Comparative Battery Z1.

### Comparative Example Z2

A battery was fabricated in the same manner as described in Example A1 above, except that the amount of the positive electrode mixture layer on the positive electrode current collector was set at 53 mg/cm².

The battery fabricated in this manner is hereinafter referred to as Comparative Battery Z2.

### Comparative Examples Z3 and Z4

Batteries were fabricated in the same manner as described in Example A1 above, except that the average particle sizes of the negative electrode active material were set at 3 μm and 20 μm, respectively.

The batteries fabricated in this manner are hereinafter referred to as Comparative Batteries Z3 and Z4, respectively.

### Experiment 1

### Theoretical Electrical Capacity Ratio of Negative Electrode to Positive Electrode

The theoretical electrical capacity ratio of the negative electrode to the positive electrode (hereinafter also referred to as “negative/positive electrode theoretical electrical capacity ratio”) was determined for each of the above-described Batteries A1 to A9 of the invention as well as Comparative Batteries Z1 to Z4, according to Equation 1 below.

When calculating the negative/positive electrode theoretical electrical capacity ratio, the theoretical electrical capacity of the negative electrode active material made of silicon powder was assumed to be 4,198 mAh/g, and the theoretical electrical capacity of the positive electrode active material made of LiCoO₂ was assumed to be 273.8 mAh/g.

In addition, it was assumed that the mass of the positive electrode active material includes that of the Li₂CO₃ existing in the positive electrode active material.

Negative/positive electrode theoretical capacity ratio=Weight of negative electrode active material per unit area (g/cm²)×Theoretical electrical capacity of negative electrode active material (mAh/g)/Weight of positive electrode active material per unit area (g/cm²)×Theoretical electrical capacity of positive electrode active material (mAh/g) (Eq. (1)

### Evaluation of Charge-Discharge Cycle Performance

Each of Batteries A1 to A9 of the invention as well as Comparative Batteries Z1 to Z4 was charged and discharged repeatedly according to the following charge-discharge conditions to evaluate the charge-discharge cycle performance. The cycle life is defined as the number of cycles at which the capacity retention ratio defined by the following Equation (2) reaches 50%.

Capacity retention ratio (%)=Discharge capacity at n-th cycle/Discharge capacity at first cycle×100 Eq. (2)

### Charge-Discharge Conditions

Charge Conditions for the First Cycle

Each of the batteries was charged at a constant current of 45 mA for 4 hours, thereafter charged at a constant current of 180 mA until the battery voltage reached 4.2 V, and further charged at a constant voltage of 4.2 V until the current value reached 45 mA.

Discharge Conditions for the First Cycle

Each of the batteries was discharged at a constant current of 180 mA until the battery voltage reached 2.75 V.

Charge Conditions for the Second Cycle Onward

Each of the batteries was charged at a constant current of 900 mA until the battery voltage reached 4.2 V and thereafter charged at a constant voltage of 4.2 V until the current value reached 45 mA.

Discharge Conditions for the Second Cycle Onward

Each of the batteries was discharged at a constant current of 900 mA until the battery voltage reached 2.75 V.

The negative/positive electrode theoretical electrical capacity ratio and cycle life were studied for each of Batteries A1 to A9 of the invention and Comparative Batteries Z1 to Z4. The results are shown in Table 1 below. It should be noted that the cycle life for each of the batteries is an index number relative to the cycle life of Battery A1 of the invention, which is taken as 100.

TABLE 1

| | Amount of | Average | | | |
|---|---|---|---|---|---|
| | positive | particle | Negative/ | | |
| | electrode | size of | positive | | |
| | active | negative | electrode | | |
| | material per 1 | electrode | theoretical | | |
| | cm² of positive | active | electrical | Shape of | |
| | electrode | material | capacity | electrode | Cycle |
| Battery | (mg/cm²) | (μm) | ratio | assembly | life |
| A1 | 36.1 | 10 | 2.13 | Cylindrical | 100 |
| A2 | | | 1.64 | | 112 |
| A3 | | | 1.37 | | 84 |
| Z1 | | | 1.14 | | 12 |
| A4 | 40.9 | | 1.88 | | 120 |
| A5 | | | 1.21 | | 81 |
| A6 | 47.5 | | 1.62 | | 103 |
| A7 | | | 1.24 | | 79 |
| Z2 | 50.4 | | 1.53 | | 23 |
| Z3 | 36.1 | 3 | 2.13 | | 38 |
| A8 | | 5.5 | | | 82 |
| A9 | | 14.5 | | | 111 |
| Z4 | | 20 | | | 41 |

### Overall Analysis

As clearly seen from Table 1, Batteries A1 to A9 of the invention exhibit better cycle performance than Comparative Batteries Z1 to Z4. In each of Batteries A1 to A9 of the invention, the amount of the positive electrode active material was 50 mg or less per 1 cm² of the positive electrode, the negative electrode active material particles have an average particle size of from 5 μm to 15 μm, and the negative/positive electrode theoretical electrical capacity ratio is 1.2 or greater, whereas each of Comparative Batteries Z1 to Z4 contains at least one of the characteristics outside the foregoing ranges.

It is believed that the results were due to the fact that Batteries A1 to A9 of the invention were able to suppress the deterioration of the lithium ion conductivity that originates from the crushing of the positive and negative electrodes and the separator due to the volumetric change of the silicon negative electrode active material during charge and discharge by controlling the amount of the positive electrode active material per 1 cm² of the positive electrode, the average particle size of the negative electrode active material, and the negative/positive electrode theoretical electrical capacity ratio to be within the foregoing ranges. Hereinbelow, each of the characteristics will be discussed.

### Analysis on Negative/Positive Theoretical Electrical Capacity Ratio

In all the Batteries A1 to A3 of the invention and Comparative Battery Z1, the amount of the positive electrode active material was 36.1 mg/cm² and the average particle size of the negative electrode active material was 10 μm. However, Comparative Battery Z1, in which the negative/positive electrode theoretical electrical capacity ratio was 1.14, showed a considerably shorter cycle life than Batteries A1 to A3 of the invention, in which the negative/positive electrode theoretical electrical capacity ratio is 1.37 or greater. This is believed to be due to the following reason.

In Comparative Battery Z1, because the negative/positive electrode theoretical electrical capacity ratio is less than 1.2, the amount of lithium occluded per one atom of the negative electrode active material, silicon, is large, so the volumetric expansion ratio of the silicon particles during charge is accordingly large. Therefore, the occurrence of fractures in the silicon particles is accelerated. When fractures occur in the silicon particles, newly exposed surfaces are produced thereon, and the active area that comes in contact with the electrolyte solution increases, and consequently, degradation and expansion of the silicon particles develop. Moreover, the development of the expansion of the silicon particles promotes the crushing of the positive and negative electrodes and the separator, so the lithium ion conductivity deteriorates as the charge-discharge cycles are repeated. As a consequence, the cycle performance becomes very short.

In contrast, in Batteries A1 to A3 of the invention, because the negative/positive electrode theoretical electrical capacity ratio is 1.2 or greater, the amount of lithium occluded per one atom of silicon/silicon alloy particles is smaller, so the volumetric expansion ratio of the silicon particles during charge is accordingly smaller. Therefore, the occurrence of fractures in the silicon particles is prevented. Accordingly, the production of the newly exposed surfaces is lessened, so the active area that comes in contact with the electrolyte solution is reduced. The degradation and expansion of the silicon particles are therefore minimized. Moreover, the development of the expansion of the silicon particles can be hindered and the crushing of the positive and negative electrodes and the separator can be minimized. Therefore, the lithium ion conductivity does not deteriorate even after the charge-discharge cycles are repeated. It is believed that a longer cycle life is obtained as a result.

### Analysis on Amount of Positive Electrode Active Material

In all the Batteries A4 to A7 of the invention and Comparative Battery Z2, the average particle size of the negative electrode active material was 10 μm and the negative/positive electrode theoretical electrical capacity ratio was 1.2 or greater. However, Comparative Battery Z2, in which the amount of the positive electrode active material was 50.4 mg/cm², showed a considerably shorter cycle life than Batteries A4 to A7 of the invention, in which the amount of the positive electrode active material was 40.9 mg/cm² or 47.5 mg/cm². This is believed to be due to the following reason.

In Comparative Battery Z2, the amount of the positive electrode active material exceeds 50 mg/cm², and therefore, the thickness of the positive electrode mixture layer is too large for the electrolyte solution to easily infiltrate into the positive electrode mixture layer (into the region near the interface between the positive electrode current collector and the positive electrode mixture layer), increasing the non-uniformity of the reactions and electrochemical polarization in the battery. Therefore, the lithium ion conductivity deteriorates. Since the decreasing of the reaction uniformity and the increase of the electrochemical polarization in the battery can be promoting factors of the battery deterioration originating from the degradation and expansion of the silicon/silicon alloy particles in the battery employing a material containing silicon/silicon alloy particles as a negative electrode active material, the lithium ion conductivity further deteriorates as the charge-discharge cycle is repeated. As a consequence, the cycle performance becomes very short.

In contrast, in Batteries A4 to A7 of the invention, the amount of the positive electrode active material was 50 mg/cm² or less, so the thickness of the positive electrode mixture layer is appropriate. Therefore, the electrolyte solution easily infiltrates into the positive electrode mixture layer, making it possible to suppress the non-uniformity of the reactions and the electrochemical polarization in the battery. In addition, this hinders the deterioration of the silicon/silicon alloy particles due to degradation and expansion, making it possible to prevent the crushing of the positive and negative electrodes and the separator. For this reason, the lithium ion conductivity does not deteriorate even when the charge-discharge cycle is repeated. It is believed that a longer cycle life is obtained as a result.

### Analysis on Average Particle Size of Negative Electrode Active Material

In all the in Batteries A8 and A9 of the invention and Comparative Batteries Z3 and Z4, the negative/positive electrode theoretical electrical capacity ratio was 2.13 and the amount of the positive electrode active material was 36.1 mg/cm². However, Comparative Batteries Z3 and Z4, in which the average particle sizes of the negative electrode active material were 3 μm and 20 μm, respectively, showed a considerably shorter cycle life than Batteries A8 and A9 of the invention, in which the average particle sizes of the negative electrode active material were 5.5 μm and 14.5 μm, respectively. This is believed to be due to the following reason.

In Comparative Battery Z3, the average particle size of the negative electrode active material is less than 5 μm, so the total surface area of the negative electrode active material is accordingly large, and the contact area between the negative electrode active material and the electrolyte solution is also large. As a consequence, the deterioration of the silicon particles (degradation or expansion) originating from the side reaction with the electrolyte solution tends to proceed easily. In addition, when the surface area of the negative electrode active material is large, the amount of the electrolyte solution retained in the negative electrode mixture layer is accordingly large. This leads to an imbalance in the amounts of the electrolyte solution between the positive and negative electrodes, and the non-uniformity of the reactions increases. In Comparative Battery Z4, the average particle size of the negative electrode active material exceeded 15 μm, so the absolute amount of the volumetric expansion of each one of the negative electrode active material particles is large when occluding lithium. Therefore, the degree of the crushing of the positive and negative electrodes and the separator increases, resulting in significant deterioration of the lithium ion conductivity. As a consequence, the cycle performance becomes very short.

In contrast, in Batteries A8 and A9 of the invention, the average particle size of the negative electrode active material is within the range of from 5 μm to 15 μm, so the contact area between the negative electrode active material and the electrolyte solution is kept small, and the deterioration (degradation or expansion) of the silicon particles originating from the side reaction with the electrolyte solution is hindered. Moreover, the surface area of the negative electrode active material is not excessively large, and therefore, the amount of the electrolyte solution retained in the negative electrode mixture layer is appropriate, resulting in a good balance in the amounts of the electrolyte solution between the positive and negative electrodes. Thus, the uniformity of the reactions can be ensured. Furthermore, since the average particle size of the negative electrode active material is appropriate, the absolute amount of the volumetric expansion of each one of the silicon/silicon alloy particles does not become excessively large when occluding lithium. Accordingly, the crushing of the positive and negative electrodes and the separator is prevented. For these reasons, the degradation in the lithium ion conductivity is prevented even when the charge-discharge cycle is repeated. It is believed that a longer cycle life is obtained as a result.

### Second Group of Examples

In the second group of examples, a study was conducted on how the amount of lithium carbonate (Li₂CO₃) in the positive electrode and the type of the positive electrode active material affect the cycle performance.

### Example B1

A battery was fabricated in the same manner as described in Example A1 of the First Group of Examples, except that the positive electrode active material used was LiNi_{0.4}Mn_{0.3}Co_{0.3}O₂ prepared in the following manner.

The battery fabricated in this manner is hereinafter referred to as Battery B1 of the invention.

First, LiOH and a coprecipitated hydroxide represented as Ni_{0.4}Mn_{0.3}Co_{0.3}(OH)₂ were mixed in a mortar so that the mole ratio of Li to the whole of the transition metals became 1:1. Thereafter, the mixture was sintered at 1000° C. for 20 hours in an air atmosphere and thereafter pulverized, to thus obtain powder of a lithium-transition metal composite oxide (positive electrode active material particles) represented as LiNi_{0.4}Mn_{0.3}Co_{0.3}O₂ and having an average particle size of 10 μm.

The resultant positive electrode active material particles had a BET specific surface area of 1.08 m²/g. The amount of the lithium carbonate (Li₂CO₃) contained in the positive electrode active material particles was determined in the same manner as described in Example 1 above, and it was found to be 0.2 mass % with respect to the net LiNi_{0.4}Mn_{0.3}Co_{0.3}O₂ (excluding lithium carbonate).

### Example B2

A battery was fabricated in the same manner as described in Example A1 above, except that the positive electrode active material used was LiNi_{0.4}Mn_{0.3}Co_{0.3}O₂ that was prepared in the following manner.

The battery fabricated in this manner is hereinafter referred to as Battery B2 of the invention.

First, LiOH and a coprecipitated hydroxide represented as Ni_{0.4}Mn_{0.3}Co_{0.3}(OH)₂ were mixed in a mortar so that the mole ratio of Li to the whole of the transition metals became 1.1:1 (LiOH was present slightly in excess). Thereafter, the mixture was sintered at 1000° C. for 20 hours in an air atmosphere and thereafter pulverized, to thus obtain powder of a lithium-transition metal composite oxide (positive electrode active material particles) represented as LiNi_{0.4}Mn_{0.3}Co_{0.3}O₂ and having an average particle size of 10 μm.

The resultant positive electrode active material particles had a BET specific surface area of 1.06 m²/g. The amount of the lithium carbonate (Li₂CO₃) contained in the positive electrode active material particles was determined in the same manner as described in Example 1 above, and it was found to be 1.8 mass % with respect to the net LiNi_{0.4}Mn_{0.3}Co_{0.3}O₂.

### Example B3

A battery was fabricated in the same manner as described in Example A1 above, except that the positive electrode active material used was LiNi_{0.82}Co_{0.18}O₂ prepared in the following manner.

The battery fabricated in this manner is hereinafter referred to as Battery B3 of the invention.

First, LiOII and a coprecipitated hydroxide represented as Ni_{0.82}Co_{0.18}(OH)₂ were mixed in a mortar so that the mole ratio of Li to the whole of the transition metals became 1:1. Thereafter, the mixture was sintered at 750° C. for 20 hours in an air atmosphere and thereafter pulverized, to thus obtain powder of a lithium-transition metal composite oxide (positive electrode active material particles) represented as LiNi_{0.82}Co_{0.18}O₂ and having an average particle size of 13 μm.

The resultant positive electrode active material particles had a BET specific surface area of 0.54 m²/g. The amount of the lithium carbonate (Li₂CO₃) contained in the positive electrode active material particles was determined in the same manner as described in Example 1 above, and it was found to be 1.5 mass % with respect to the net LiNi_{0.82}Co_{0.18}O₂.

### Example B4

A battery was fabricated in the same manner as described in Example A1 above, except that the positive electrode active material used was LiNi_{0.8}Co_{0.15}Al_{0.05}O₂ prepared in the following manner.

The battery fabricated in this manner is hereinafter referred to as Battery B4 of the invention.

First, LiOH and a coprecipitated hydroxide represented as Ni_{0.8}Co_{0.15}Al_{0.05}(OH)₂ were mixed in a mortar so that the mole ratio of Li to the whole of the transition metals became 1:1. Thereafter, the mixture was sintered at 950° C. for 12 hours in an air atmosphere and thereafter pulverized, to thus obtain powder of a lithium-transition metal composite oxide (positive electrode active material particles) represented as LiNi_{0.8}Co_{0.15}Al_{0.05}O₂ and having an average particle size of 15 μm.

The resultant positive electrode active material particles had a BET specific surface area of 0.51 m²/g. The amount of the lithium carbonate (Li₂CO₃) contained in the positive electrode active material particles was determined in the same manner as described in Example 1 above, and it was found to be 0.8 mass % with respect to the net LiNi_{0.8}Co_{0.15}Al_{0.05}O₂.

### Experiment

The negative/positive electrode theoretical electrical capacity ratio and cycle life were studied for each of Batteries B1 to B4 of the invention. The results are shown in Table 2 below.

The calculation method for negative/positive electrode theoretical electrical capacity ratio and the charge-discharge cycle conditions were the same as described in the experiment in the First Group of Examples. It should be noted that when calculating the negative/positive electrode theoretical electrical capacity ratio, the theoretical electrical capacity of LiNi_{0.4}Mn_{0.3}Co_{0.30}₂ was assumed to be 277.5 mAh/g, that of LiNi_{0.82}Co_{0.18}O₂ was assumed to be 274.4 mAh/g, and that of LiNi_{0.8}Co_{0.15}Al_{0.05}O₂ was assumed to be 282.9 mAh/g.

Table 2 also shows the results for the foregoing Battery A1 of the invention. It should be noted that in Table 2, the cycle life for each of the batteries is an index number relative to the cycle life of Battery A1 of the invention, which is defined as 100.

TABLE 2

| | | | Amount of | | | |
|---|---|---|---|---|---|---|
| | | | positive | | | |
| | | Amount of | electrode | | | |
| | | Li₂CO₃ in | active | | | |
| | | positive | material | Negative/positive | | |
| | | electrode | per 1 cm² | electrode | | |
| | | active | of positive | theoretical | Shape of | |
| | Positive electrode | material | electrode | electrical | electrode | Cycle |
| Battery | active material | (mass %) | (mg/cm²) | capacity ratio | assembly | life |
| A1 | LiCoO₂ | 0.05 | 36.1 | 2.13 | Cylindrical | 100 |
| B1 | LiNi_{0.4}Mn_{0.3}Co_{0.3}O₂ | 0.2 | | 2.10 | | 165 |
| B2 | LiNi_{0.4}Mn_{0.3}Co_{0.3}O₂ | 1.8 | | 2.10 | | 182 |
| B3 | LiNi_{0.82}Co_{0.18}O₂ | 1.5 | | 2.12 | | 255 |
| B4 | LiNi_{0.8}Co_{0.15}Al_{0.05}O₂ | 0.8 | | 2.06 | | 220 |

### Analysis on Proportion of Lithium Carbonate

The results shown in Table 2 demonstrate the following. In all the batteries, the amount of the positive electrode active material was 50 mg/cm² or less, the average particle size of the negative electrode active material was from 5 μm to 15 μm, and the theoretical electrical capacity ratio was 1.2 or greater. Nevertheless, Batteries B1 to B4 of the invention, in which the amount of the lithium carbonate existing in the positive electrode active material (the amount of Li₂CO₃ with respect to the total amount of the positive electrode active material) is 0.2 mass % or greater, exhibit superior cycle performance to Battery A1 of the invention, in which the amount of lithium carbonate is less than 0.2 mass %. This is believed to be due to the following reason.

During charge, in other words, when lithium is deintercalated from the positive electrode active material and the potential of the positive electrode is elevated, Li₂CO₃ existing in the positive electrode is decomposed by the elevated potential and generates CO₂. The resulting CO₂ serves to smoothly cause the lithium occlusion/release reactions at the negative electrode active material surface and additionally to lessen the side reactions. Therefore, the deterioration (expansion) of the silicon/silicon alloy particles is lessened. However, if the amount of lithium carbonate is less than 0.2 mass % as in Battery A1 of the invention, the effect of adding lithium carbonate is not exhibited fully. On the other hand, it is believed that if the amount of lithium carbonate is 0.2 mass % or greater as in Batteries B1 to B4 of the invention, the effect of adding lithium carbonate is exhibited sufficiently.

It should be noted that the reason why Batteries B1 to B4 of the invention contain greater amounts of lithium carbonate in the positive electrode active material than Battery A1 of the invention is that Batteries B 1 to B4 of the invention contain Ni, which helps to generate Li₂CO₃ easily by the reaction between CO₂ and the lithium component in the lithium-transition metal composite oxide, in the positive electrode active material. In Batteries B2 to B4 of the invention, the amount of lithium carbonate is especially large because in Battery B2 of the invention LiOH is controlled to be present slightly in excess when preparing a mixture with a coprecipitated hydroxide represented as Ni_{0.4}Mn_{0.3}Co_{0.3}(OH)₂, and in Batteries B3 and B4 of the invention, the proportion of Ni is set to be especially high.

### Analysis on Type of Lithium-Transition Metal Composite Oxide

It will be appreciated that Batteries B3 and B4 of the invention, which use a lithium-transition metal composite oxide represented by the chemical formula LiₐNi_{b}Co_{c}AlₑO₂, where 0≦a≦1.1, b+c+e=1, 0<b≦0.85, 0<c≦0.2, and 0≦e≦0.1 as the positive electrode active material, exhibit particularly superior cycle performance to Batteries A1, B1 and B2 of the invention, which use lithium-transition metal composite oxides represented by chemical formulas other than the foregoing formula.

The reason is believed to be as follows. The layered lithium-transition metal composite oxide represented by the chemical formula LiₐNi_{b}Co_{c}AlₑO₂, where 0≦a≦1.1, b+c+e=1, 0≦b<0.85, 0<c≦0.2, and 0≦e≦0.1 has a highly stable crystal structure even when at a high potential during charge, less transition metal ions dissolve away from the oxide. Therefore, side reactions in the battery are suppressed, and the expansion of the silicon active material particles is also minimized.

### Third Group of Examples

In the third group of examples, a study was conducted on how the physical properties of the separator affect the cycle performance.

### Example C

A battery was fabricated in the same manner as described in Example A1 above, except that the separator used was a porous polyethylene film having a penetration resistance of 390 g and a porosity of 47% (thickness: 20 μm, length: 600 mm, width: 37.7 mm).

The battery fabricated in this manner is hereinafter referred to as Battery C of the invention.

### Experiment

The cycle life was studied for Battery C of the invention. The results are shown in Table 3 below.

The charge-discharge cycle conditions were the same as described in the experiment in the First Group of Examples. Table 3 also shows the results for the foregoing Battery A1 of the invention. It should be noted that in Table 3, the cycle life for each of the batteries is an index number relative to the cycle life of Battery A1 of the invention, which is defined as 100.

TABLE 3

| | Separator | | Shape of | |
|---|---|---|---|---|
| | Penetration resistance | Porosity | electrode | |
| Battery | (g) | (%) | assembly | Cycle life |
| C | 390 | 47 | Cylindrical | 123 |
| A1 | 340 | 39 | | 100 |

The results shown in Table 3 demonstrate the following. Although Battery C of the invention has the same amount of the positive electrode active material, the same average particle size of the negative electrode active material, and the same theoretical electrical capacity ratio as those of Battery A1 of the invention, Battery C of the invention, which has a separator penetration resistance of 350 g or greater and a porosity 40% or greater, exhibits superior cycle performance to Battery A1 of the invention, which has a less separator penetration resistance and a less porosity.

It is believed that in Battery C of the invention, which has a separator penetration resistance of 350 g or greater and a porosity 40% or greater, the clogging of the separator resulting from the crushing does not easily occur, and the lithium ion conductivity is prevented from decreasing even when the expansion of the silicon negative electrode active material develops.

### Reference Examples

In the present reference example, flat-type batteries employing a flat-type spirally-wound electrode assembly were fabricated, and a study was conducted on how the difference in the battery configurations affect the cycle performance. The structure and manufacturing method of the flat-shaped battery are as follows.

### Structure of Flat-Type Battery

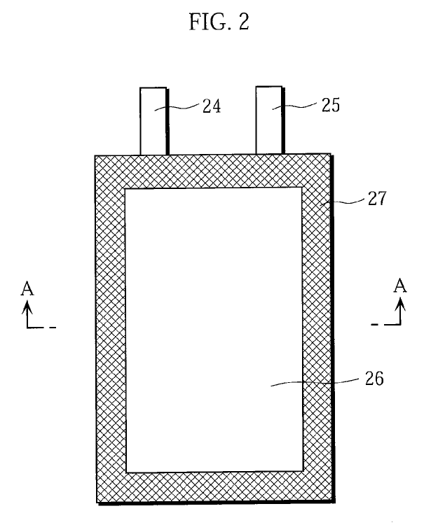

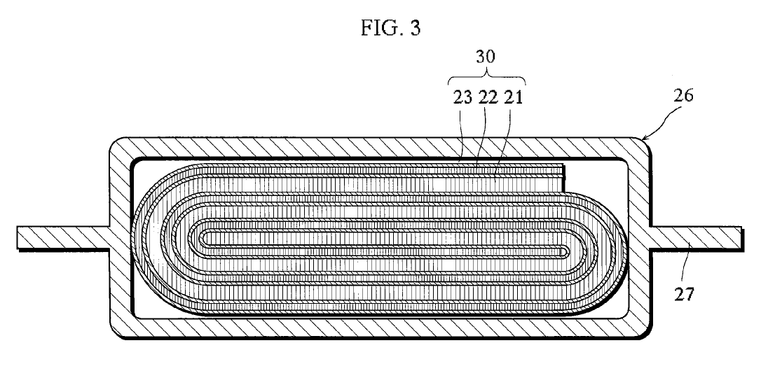

As illustrated in FIGS. 2 and 3, a flat-shaped battery has a flat-type spirally-wound electrode assembly 30 in which a positive electrode 21 and a negative electrode 22 are disposed facing each other across a separator 23, and the flat-type spirally-wound electrode assembly 30 is disposed in the space in a battery case 26 made of a laminate film having a sealed part 27 in which the peripheral edges are heat-sealed to each other. In the battery with such a structure, a positive electrode current collector tab 24 attached to the positive electrode 21 and a negative electrode current collector tab 25 attached to the negative electrode 22 are disposed protruding outwardly, so that charge and discharge operations are possible as a secondary battery.

### Preparation of Flat-Type Battery

First, after preparing the positive and negative electrodes and the separator, the positive electrode and the negative electrode were disposed facing each other across the separator, and they were spirally wound with a 18 mm-diameter winding core so that the positive electrode tab and the negative electrode tab are both at the outermost. Subsequently, the winding core was drawn out to prepare a spirally-wound electrode assembly, and thereafter, the spirally-wound electrode assembly was compressed to obtain a flat-type spirally-wound electrode assembly. Next, the flat-type spirally-wound electrode assembly and the electrolyte solution were inserted into a bag-like battery case made of aluminum laminate (three-sides of which were sealed by welding) in a CO₂ atmosphere at 25° C. and 1 atm, and the remaining one side was sealed by welding, to complete a flat-type battery. The electrolyte solution and the separator used were the same as those used in Example A1 in the First group of Examples.

### Reference Example Y1

A cylindrical battery as described above was fabricated using the positive electrode and the negative electrode shown in Example 1 of the First Group of Examples.

The battery fabricated in this manner is hereinafter referred to as Reference Battery Y1.

### Reference Examples Y2 to Y5

Batteries were fabricated in the same manner as described in Reference Example Y1 above, except that respective batteries used the positive and negative electrodes described in Comparative Example Z1 of the first group of examples, those described in Comparative Example Z2 of the first group of examples, those described in Comparative Example Z3 of the first group of examples, and those described in Comparative Example Z4 of the first group of examples.

The batteries fabricated in this manner are hereinafter referred to as Reference Batteries Y2 to Y5, respectively.

### Experiment

The negative/positive electrode theoretical electrical capacity ratio and cycle life were studied for each of Reference Batteries Y1 to Y5. The results are shown in Table 4 below. The calculation method for negative/positive electrode theoretical electrical capacity ratio and the charge-discharge cycle conditions were the same as described in the experiment in the First Group of Examples. It should be noted that the cycle life for each of the batteries is an index number relative to the cycle life of Reference Battery Y1, which is defined as 100.

TABLE 4

| | Amount of | | Negative/ | | |
|---|---|---|---|---|---|
| | positive | Average | positive | | |
| | electrode active | particle size of | electrode | | |
| | material per 1 | positive | theoretical | | |
| | cm² of positive | electrode | electrical | Shape of | |
| | electrode | active material | capacity | electrode | Cycle |
| Battery | (mg/cm²) | (μm) | ratio | assembly | life |
| Y1 | 36.1 | 10 | 2.13 | Flat | 100 |
| Y2 | | | 1.14 | | 73 |
| Y3 | 50.4 | | 1.53 | | 112 |
| Y4 | 36.1 | 3 | 2.13 | | 68 |
| Y5 | | 20 | | | 91 |

The results shown in Table 4 demonstrate that in Reference Batteries Y1 to Y5, which have a flat electrode assembly configuration, the amount of the positive electrode active material, the average particle size of the negative electrode active material, and the negative/positive electrode theoretical electrical capacity ratio have less influence on the cycle performance, unlike Batteries A1 to A9 of the invention and Comparative Batteries Z1 to Z4, which have a cylindrical electrode assembly configuration.

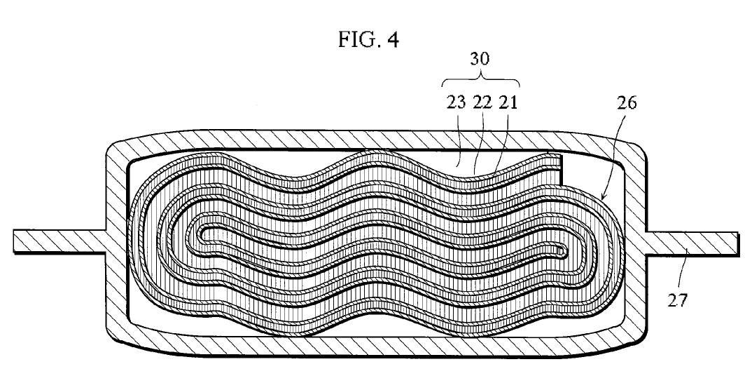

It is believed that deformation of the electrode assembly 30 itself tends to occur easily in a flat-shaped battery, as illustrated in FIG. 4, so the decrease of the lithium ion conductivity originating from the crushing of the positive and negative electrodes 21, 22 and the separator 23 does not occur easily due to the volumetric change of the negative electrode active material made of silicon/silicon alloy particles during charge and discharge.

Thus, it will be appreciated that the effect of improving the cycle performance by controlling the amount of the positive electrode active material, the average particle size of the negative electrode active material, and the negative/positive electrode theoretical electrical capacity ratio according to the present invention is intrinsic to cylindrical batteries.

The present invention is applicable to, for example, driving power sources for mobile information terminals such as mobile telephones, notebook computers, and PDAs.

Only selected embodiments have been chosen to illustrate the present invention. To those skilled in the art, however, it will be apparent from the foregoing disclosure that various changes and modifications can be made herein without departing from the scope of the invention as defined in the appended claims. Furthermore, the foregoing description of the embodiments according to the present invention is provided for illustration only, and not for limiting the invention as defined by the appended claims and their equivalents.

What is claimed is:

1. A cylindrical lithium secondary battery comprising:
a battery case;
a non-aqueous electrolyte; and
a spirally-wound electrode assembly accommodated in the battery case, the spirally-wound electrode assembly comprising a positive electrode, a negative electrode, and a separator interposed between the positive and negative electrodes, the positive electrode and the negative electrode being disposed facing each other across the separator,
the positive electrode having a positive electrode current collector made of a conductive metal foil and a positive electrode mixture layer disposed on a surface of the positive electrode current collector, the positive electrode mixture layer comprising a positive electrode binder and a positive electrode active material containing a layered lithium-transition metal composite oxide represented by the chemical formula LiₐNi_{b}Co_{c}Mn_{d}AlₑO₂ where 0≦a≦1.1, b+c+d+e=1, 0≦b≦1, 0≦c≦1, 0≦d≦1, and 0≦e≦0.1, wherein the amount of the positive electrode active material is 50 mg or less per 1 cm² of the positive electrode, and
the negative electrode having a negative electrode current collector made of a conductive metal foil and a negative electrode mixture layer disposed on a surface of the negative electrode current collector, the negative electrode mixture layer comprising a negative electrode binder and a negative electrode active material containing silicon particles and/or silicon alloy particles, wherein the average particle size of the silicon particles or the silicon alloy particles is from 5 μm to 15 μm, and
wherein the theoretical electrical capacity ratio of the negative electrode to the positive electrode is 1.2 or greater.

2. The cylindrical lithium secondary battery according to claim 1, wherein the positive electrode contains Li₂CO₃, and the amount of the Li₂CO₃ with respect to the total amount of the positive electrode active material is 0.2 mass % or greater.

3. The cylindrical lithium secondary battery according to claim 2, wherein the Li₂CO₃ exists on a surface of the positive electrode active material.

4. The cylindrical lithium secondary battery according to claim 1, wherein the positive electrode active material contains a layered lithium-transition metal composite oxide represented by the chemical formula LiₐNi_{b}Co_{c}AlₑO₂, where 0≦a≦1.1, b+c+e=1, 0<b≦0.85, 0<c≦0.2, and 0≦e≦0.1.

5. The cylindrical lithium secondary battery according to claim 2, wherein the positive electrode active material contains a layered lithium-transition metal composite oxide represented by the chemical formula LiₐNi_{b}Co_{cf}AlₑO₂, where 0≦a≦1.1, b+c+e=1, 0≦b<0.85, 0<c≦0.2, and 0≦e≦0.1.

6. The cylindrical lithium secondary battery according to claim 1, wherein the separator is made of a microporous polyethylene film, and the microporous film has a penetration resistance of 350 g or greater and a porosity of 40% or greater.

7. The cylindrical lithium secondary battery according to claim 2, wherein the separator is made of a microporous polyethylene film, and the microporous film has a penetration resistance of 350 g or greater and a porosity of 40% or greater.

8. The cylindrical lithium secondary battery according to claim 1, wherein the silicon particles and the silicon alloy particles have a crystallite size of 100 nm or less.

9. The cylindrical lithium secondary battery according to claim 2, wherein the silicon particles and the silicon alloy particles have a crystallite size of 100 nm or less.

10. The cylindrical lithium secondary battery according to claim 1, wherein the silicon particles and the silicon alloy particles are prepared by thermally decomposing, or thermally reducing, a material containing a silane compound.

11. The cylindrical lithium secondary battery according to claim 2, wherein the silicon particles and the silicon alloy particles are prepared by thermally decomposing, or thermally reducing, a material containing a silane compound.

12. The cylindrical lithium secondary battery according to claim 1, wherein the silicon particles and the silicon alloy particles contain oxygen and, as an impurity, at least one element selected from the group consisting of phosphorus, boron, aluminum, iron, calcium, sodium, gallium, lithium, and indium.

13. The cylindrical lithium secondary battery according to claim 2, wherein the silicon particles and the silicon alloy particles contain oxygen and, as an impurity, at least one element selected from the group consisting of phosphorus, boron, aluminum, iron, calcium, sodium, gallium, lithium, and indium.

14. The cylindrical lithium secondary battery according to claim 1, wherein the negative electrode binder comprises a thermoplastic resin.

15. The cylindrical lithium secondary battery according to claim 2, wherein the negative electrode binder comprises a thermoplastic resin.

16. The cylindrical lithium secondary battery according to claim 14, wherein the thermoplastic resin comprises a polyimide resin.

17. The cylindrical lithium secondary battery according to claim 15, wherein the thermoplastic resin comprises a polyimide resin.

18. The cylindrical lithium secondary battery according to claim 1, wherein the negative electrode active material layer contains graphite powder.

19. The cylindrical lithium secondary battery according to claim 2, wherein the negative electrode active material layer contains graphite powder.

20. The cylindrical lithium secondary battery according to claim 18, wherein the average particle size of the graphite powder is from 3 μm to 15 μm, and the amount of the graphite powder with respect to the total amount of the negative electrode active material is from 3 mass % to 20 mass %.

21. The cylindrical lithium secondary battery according to claim 19, wherein the average particle size of the graphite powder is from 3 μm to 15 μm, and the amount of the graphite powder with respect to the total amount of the negative electrode active material is from 3 mass % to 20 mass %.

22. The cylindrical lithium secondary battery according to claim 1, wherein the non-aqueous electrolyte contains CO₂ and/or fluoroethylene carbonate.

23. The cylindrical lithium secondary battery according to claim 2, wherein the non-aqueous electrolyte contains CO₂ and/or fluoroethylene carbonate.

24. A method of manufacturing a cylindrical lithium secondary battery, comprising:
applying a positive electrode mixture slurry containing a positive electrode binder and a positive electrode active material onto a surface of a positive electrode current collector made of a conductive metal foil so that the amount of the positive electrode active material is 50 mg or less per 1 cm² of the positive electrode, the positive electrode active material containing a layered lithium-transition metal composite oxide represented by the chemical formula LiₐNi_{b}Co_{c}Mn_{d}AlₑO₂ where 0≦a≦1.1, b+c+d+e=1, 0≦b≦1, 0≦c≦1, 0≦d≦1, and 0≦e≦0.1, to thereby prepare a positive electrode in which a positive electrode mixture layer is formed on the surface of the positive electrode current collector;
applying a negative electrode mixture slurry containing a negative electrode binder and a negative electrode active material containing silicon particles and/or silicon alloy particles having an average particle size of from 5 μm to 15 μm, onto a surface of a negative electrode current collector made of a conductive metal foil so that the theoretical electrical capacity ratio of the negative electrode to the positive electrode is 1.2 or greater, to thereby prepare a negative electrode in which a negative electrode mixture layer is formed on the surface of the negative electrode current collector; and
spirally winding the positive and negative electrodes with a separator interposed therebetween to prepare a spirally-wound electrode assembly, thereafter putting the spirally-wound electrode assembly into a battery case, and filling a non-aqueous electrolyte into the battery case.

25. The method according to claim 24, wherein the silicon particles and the silicon alloy particles used are prepared by thermally decomposing, or thermally reducing, a material containing a silane compound.
